(19) United States
(12) Patent Application Publication
(10) Pub. No.: US 2012/0253551 A1
(43) Pub. Date: Oct. 4, 2012

(54) Systems and Methods for Providing Telematic Services to Vehicles

(76) Inventors: Sammy Halimi, Carrollton, TX (US); Craig George Kenneth Copland, Beverly, MA (US); James Bonasera, Rowley, MA (US); Steven Deeb, Rowley, MA (US); Bharath Yanamula, Irving, TX (US); Karuthapandian R. Sanker, Waltham, MA (US)

(21) Appl. No.: 13/524,588

(22) Filed: Jun. 15, 2012

Related U.S. Application Data
(63) Continuation-in-part of application No. 12/541,496, filed on Aug. 14, 2009.
Application No. 12/541,496 is a continuation-in-part of application No. 12/729,573, filed on Mar. 23, 2010.
Application No. 12/729,573 is a continuation-in-part of application No. 12/636,327, filed on Dec. 11, 2009.
Application No. 12/636,327 is a continuation-in-part of application No. 12/363,267, filed on Jan. 30, 2009.
Application No. 12/363,267 is a continuation-in-part of application No. 13/033,046, filed on Feb. 23, 2011.
Application No. 13/033,046 is a continuation-in-part of application No. 13/033,083, filed on Feb. 23, 2011.
Application No. 13/033,083 is a continuation-in-part of application No. 13/033,112, filed on Feb. 23, 2011.
Application No. 13/033,112 is a continuation-in-part of application No. 13/033,167, filed on Feb. 23, 2011.
Application No. 13/033,167 is a continuation-in-part of application No. 13/033,185, filed on Feb. 23, 2011.
(60) Provisional application No. 61/497,934, filed on Jun. 16, 2011.
(60) Provisional application No. 61/497,699, filed on Jun. 16, 2011.
(60) Provisional application No. 61/497,705, filed on Jun. 16, 2011.
(60) Provisional application No. 61/497,715, filed on Jun. 16, 2011.
(60) Provisional application No. 61/497,768, filed on Jun. 16, 2011.
(60) Provisional application No. 61/497,849, filed on Jun. 16, 2011.

(51) Int. Cl. G06F 17/00

(52) U.S. Cl. 701/1

(57) ABSTRACT

A method for providing abstraction in a telematics system provides a telematics system with components, the components including a translator that converts messages received from a vehicle into a canonical form and an adapter that converts data received from an external source into a canonical equivalent. The translator interprets the received messages and routes the received messages to a correct component of the telematics system. The adapter is operable to allow a content services subsystem to deliver the received data.

### CROSS-REFERENCE TO RELATED APPLICATION

This application claims the priority, under 35 U.S.C. §119, of co-pending:
U.S. Provisional Application Ser. No. 61/497,934, filed on Jun. 16, 2011 [Atty. Docket: Agero/Endeavor];
U.S. Provisional Application Ser. No. 61/497,699, filed on Jun. 16, 2011 [Atty. Docket: Agero/Open Dialog];
U.S. Provisional Application Ser. No. 61/497,705, filed on Jun. 16, 2011 [Atty. Docket: Agero/Prompt Mgmt];
U.S. Provisional Application Ser. No. 61/497,715, filed on Jun. 16, 2011 [Atty. Docket: Agero/Communications];
U.S. Provisional Application Ser. No. 61/497,768, filed on Jun. 16, 2011 [Atty. Docket: Agero/Content]; and
U.S. Provisional Application Ser. No. 61/497,849, filed on Jun. 16, 2011 [Atty. Docket: Agero/Marketing];
   the prior applications are herewith incorporated by reference herein in their entireties.

This application is:
a continuation-in-part of U.S. patent application Ser. No. 12/541,496 [Atty. Docket: Agero/Criteria], filed on Aug. 14, 2009 (which claims the benefit of U.S. Provisional Application No. 61/089,148, filed on Aug. 15, 2008);
a continuation-in-part of U.S. patent application Ser. No. 12/729,573 [Atty. Docket: Agero/Service Oriented], filed on Mar. 23, 2010 (which claims the benefit of U.S. Provisional Application No. 61/288,067, filed on Mar. 24, 2009);
a continuation-in-part of U.S. Pat. No. 7,373,248 [Atty. Docket: Agero/Voice Delivered] (which claims the benefit of U.S. Provisional Application No. 60/608,850, filed on Sep. 10, 2004);
a continuation-in-part of U.S. Pat. No. 7,634,357 [Atty. Docket: AGERO/Voice Delivered DIV1], which is a divisional of U.S. Pat. No. 7,373,248;
a continuation-in-part of U.S. patent application Ser. No. 12/636,327, filed Dec. 11, 2009 [Atty. Docket: AGERO/Voice Delivered DIV2], which is a divisional application of U.S. Pat. Nos. 7,373,248 and 7,634,357;
a continuation-in-part application of U.S. patent application Ser. No. 12/363,267 [Atty. Docket Agero/Bluetooth], filed Jan. 30, 2009 (which application claims the priority, under 35 U.S.C. §119, of U.S. Provisional Patent Application Ser. No. 61/024,956, filed Jan. 31, 2008);
a continuation-in-part application of U.S. patent application Ser. No. 13/033,046, filed Feb. 23, 2011 [Atty. Docket Agero/Bluetooth DIV1];
a continuation-in-part application of U.S. patent application Ser. No. 13/033,083, filed Feb. 23, 2011 [Atty. Docket Agero/Bluetooth DIV2];
a continuation-in-part application of U.S. patent application Ser. No. 13/033,112, filed Feb. 23, 2011 [Atty. Docket Agero/Bluetooth DIV3];
a continuation-in-part application of U.S. patent application Ser. No. 13/033,167, filed Feb. 23, 2011 [Atty. Docket Agero/Bluetooth DIV4];
a continuation-in-part application of U.S. patent application Ser. No. 13/033,185, filed Feb. 23, 2011 [Atty. Docket Agero/Bluetooth DIV5],
   the entire disclosures of all of the above-listed applications are hereby incorporated herein by reference in their entireties.

### FIELD OF THE INVENTION

The present invention relates to systems and methods for providing telematics services to vehicles. More particularly, the present invention pertains to telematics systems and methods utilizing a flexible, modular, and scalable cloud-based telematics platform operable to deliver data intensive telematics services to various customers with a high level of service customization, but without having to develop complete custom solutions.

### BACKGROUND OF THE INVENTION

The advent of telematics services, which were introduced over a decade ago, brought with it a trend to incorporate the ability of a vehicle to communicate with remote data centers and transmit location data and vehicle information related to safety, security, and emergency breakdown. “Telematics,” as it is referred to in the art, includes the integration of wireless communications, vehicle monitoring systems, and location devices. Such technologies in automotive communications combine wireless voice and data capability for management of information and safety applications.

Telematics technology is in a period of transition. The traditional perspective of telematics as a way to track vehicles as assets has given way to a comprehensive view of telematics as a core function that supports safety, security, and entertainment in the vehicle. In a fundamental sense, telematics is becoming the key mechanism by which drivers extract additional value from their investment in their cars. Manufacturers can exploit this mechanism and thereby improve the customer's perceived value of the product, and engender loyalty in an increasingly fickle customer base.

Most of the early telematics communication was achieved through wireless voice channels that were analog in nature. By law in 2008, all analog connectivity became digital and, consequently, data connectivity, such as “3G” technology, became a readily available measure for mobile devices to “connect” to the Internet. As a result of these advances, the vehicle is also being adapted to leverage data connectivity in combination with voice channel connectivity in what is referred to as the “connected car” concept.

The “connected car” concept has continued to evolve over the past few years and commercial launches of rather sophisticated vehicle services are becoming a reality. These services often rely on vehicle location and “on cloud computing,” defined as web services accessed over a data channel. Examples of these services include off-board routing, destination capture, remote-vehicle diagnostics, music downloads, traffic reporting, local searches, access to concierge services, connecting to a vehicle dealer, and roadside assistance. The term “off-board” as used herein refers to a location away from and outside the vehicle. The term “local search” as used herein refers to a point-of-interest (POI) search based on proximity to a specific location. The examples given above are regarded as being vehicle-centric in nature and many invoke some form of vocal communication with a live agent or an off-board interactive automation system.

Many of these telematics-enabled services are more data intensive than traditional navigation and safety signals and require correspondingly more processing power to receive, process, manage and deliver them. The sheer number of variations in the services offered also requires re-thinking the systems needed to support this new environment.

There are significant challenges to servicing ever more manufacturers who offer more services to more subscribers while supporting the manufacturers' desire to differentiate those services from their competitors due to conflicting interests and requirements. On the surface, it appears to be a dichotomy where the only choices are to deliver identical services to every manufacturer, or invest considerable effort in creating a fully-custom suite of services for each manufacturer. However, this dichotomy exists only when any of the following conditions exist: knowledge of the specifics of each OEM solution is dispersed throughout the system; knowledge of the transport and protocols used are dispersed throughout the system; internal data is modeled to reflect how the data is provided by the manufacturer or partners; or variations in service delivery are propagated throughout the system.

Therefore, there is a need in the art to provide customers, e.g., OEMs, with a fully customized telematics solution without having to develop complete custom solutions. It would be a substantial improvement in the art to provide a more standardized approach, reusing only the functional environment of the telematics platform (i.e., database, runtime, customer relationship management (CRM), and telephony) across OEMs, but still allowing complete replacement of business logic, protocols, object-relational mappings, and content sources when implementing a new OEM solution.

As shown in FIG. 1, there is a clear cost-benefit tradeoff between highly-customized and highly-standardized approaches. Thus, a telematics platform designed to move the line to the right in FIG. 1, yet still possess the capability to provide customized telematics solutions to customers, would be a significant advancement in the art.

### SUMMARY OF THE INVENTION

Systems and methods for providing data intensive telematics services to vehicles using a flexible, modular, and scalable Platform as a Service (PaaS) based telematics system are disclosed. A telematics system includes a cloud-based telematics platform capable of supporting new OEMs with a high level of service customization, but without the historical overhead of developing a completely custom solution.

The flexibility of the telematics system is derived from the basic principle of keeping internal data and processing separate from the external OEM-specific data and processing. Additional benefits are obtained through a modular and scalable approach to implementing the telematics system. The underlying flexibility of the system also allows major, external components to be changed out with minimal impact to the system. The telematics system can be deployed in an environment where a fully custom solution would be cost-prohibitive.

Customization is achieved through a combination of configuration options, tunable service routing rules, and customer preferences. The telematics system can be accessed through a number of delivery channels including operator, interactive voice response (IVR), and web interfaces.

A cloud-based telematics system provides telematics services to connected vehicles through open web services that allow the integration of various subsystems with existing and new end points within the telematics supply chain.

The subsystems of the telematics system include a telematics services subsystem, a gateway services subsystem, an interactive voice response (IVR) subsystem, a consumer web interface, a call center interface, a call center user interface, a telephony interface, a data services subsystem, and a content services subsystem. These subsystems communicate with each other through standardized, internal interfaces. Translator and adapter plug-ins are used to convert data into a structure that is compatible with the method in which it will be extracted or accessed, thereby providing an interface through which various applications can connect and allowing integration of new sources of data in a short amount of time.

With the foregoing and other objects in view, there is provided, in accordance with the invention, a method for providing abstraction in a telematics system includes providing a telematics system with components. The components include a translator that converts messages received from a vehicle into a canonical form and an adapter that converts data received from an external source into a canonical equivalent. The translator interprets the received messages and routes the received messages to a correct component of the telematics system. The adapter is operable to allow a content services subsystem to deliver the received data.

In accordance with another mode of the invention, determining an origin of the messages or the data is unnecessary in order for at least one of the translator and the adapter to use the messages or the data.

In accordance with a further mode of the invention, there is provided the step of exchanging messages by the components represented in canonical form.

In accordance with an added mode of the invention, the received data comprises at least one of points of interest, contacts, vehicle data, and other data stored outside of the telematics system.

In accordance with an additional mode of the invention, the components of the telematics system are modular and discrete.

In accordance with yet another mode of the invention, code for the components of the telematics system is free of original equipment manufacturer (OEM) specific details.

In accordance with yet a further mode of the invention, the components are discrete and additional instances of at least one of the discrete components are added to increase capacity.

In accordance with yet an added mode of the invention, the telematics system is implemented as a stand-alone system.

In accordance with yet an additional mode of the invention, the telematics system is implemented as an integrated platform operable to service many customers.

In accordance with again another mode of the invention, the telematics system uses code frameworks to standardize a behavior of common parts of the telematics system.

In accordance with again a further mode of the invention, the code frameworks are operable to send and receive the data.

In accordance with again an added mode of the invention, the code frameworks are operable to audit operations.

In accordance with again an additional mode of the invention, the code frameworks are operable to read and write configuration data.

In accordance with still another mode of the invention, the code frameworks are operable to handle error conditions.

In accordance with still a further mode of the invention, the code frameworks are operable to route service requests.

In accordance with still an added mode of the invention, the telematics system is provided with a set of routing rules that are consulted for each instance of a service request.

With the objects of the invention in view, there is also provided a telematics system comprises components including a translator operable to convert messages received from a vehicle into a canonical form, to interpret the received messages, and to route the received messages to a correct one of the components and an adapter operable to convert data received from an external source into a canonical equivalent and to permit delivery the received data by a content services subsystem.

In accordance with still an additional feature of the invention, the telematics system is modular and the components are discrete components.

In accordance with still an additional feature of the invention, the components are implemented as a stand-alone telematics system.

In accordance with a concomitant feature of the invention, the components are implemented as an integrated telematics platform operable to service many customers.

Although the disclosure is illustrated and described herein as embodied in PaaS-based telematics systems and methods for providing telematics services to vehicles, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 illustrates the cost-benefit tradeoff between highly-customized and highly-standardized approaches;

FIG. 2 is a block diagram of a PaaS-based telematics system in accordance with an exemplary embodiment;

FIG. 3 is a diagrammatic illustration of an exemplary content services subsystem of the telematics system of FIG. 2;

FIG. 4 is a pictorial representation of how frameworks relate to the functional components within the telematics system of FIG. 2;

FIG. 5 is a block diagram of an architecture of a telematics system in accordance with an exemplary embodiment;

FIG. 6 is a block diagram depicting a telematics system interface in accordance with an exemplary embodiment;

FIG. 7 is a table of exemplary telematics services deliverable by a telematics system in accordance with an exemplary embodiment;

FIG. 8 is a block diagram depicting a data sync process for exposing and exchanging data with third parties in accordance with an exemplary embodiment; and

FIGS. 9 and 10 are tables of exemplary events for which the data sync process of FIG. 8 can be used.

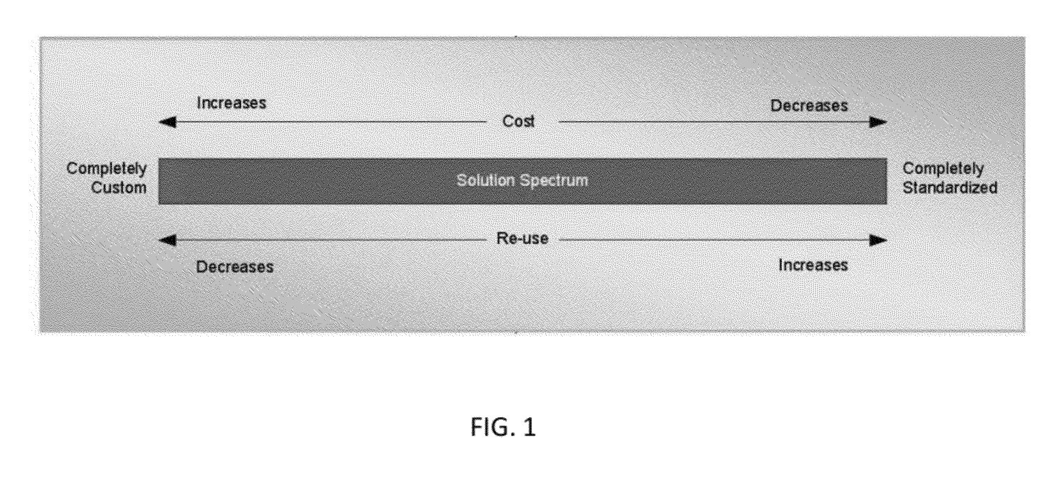

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. It is believed that the invention will be better understood from a consideration of the following description in conjunction with the drawing figures, in which like reference numerals are carried forward. The figures of the drawing are not drawn to scale.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

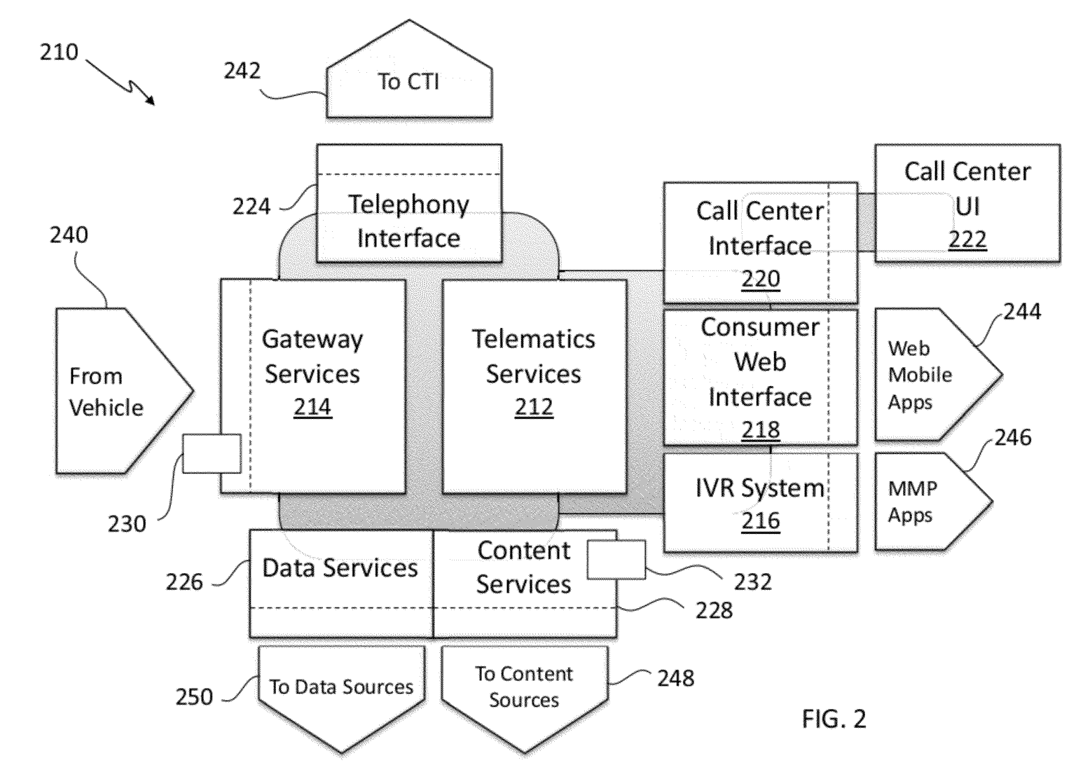

Referring now to the figures of the drawings in detail and first, particularly to FIG. 2, an exemplary PaaS-based telematics system 210 is described. The telematics system 210 provides data intensive telematics services to connected vehicles through a telematics platform of interfaces that simplify the creation of connected vehicle solutions for automotive OEMs, their partners, and any other potential third party customer. As its primary components, the exemplary telematics system 210 includes a number of components or subsystems: a telematics services subsystem 212; a gateway services subsystem 214; an interactive voice response (IVR) subsystem 216; a consumer web interface 218; a call center interface 220 and call center user interface 222; a telephony interface 224; a data services subsystem 226; and a content services subsystem 228.

The telematics system 210 provides an end-to-end telematics solution through open web services that allow integration of the subsystems 212, 214, 216, 218, 220, 222, 224, 226, 228 with existing and new end-points within the telematics supply chain. External integration points within the overall system 210 are designated by the dashed lines in each of the subsystems 212, 216, 218, 220, 224, 226, 228, which communicate with each other through standardized, internal interfaces with strictly defined data and invocation sequences. These interfaces are referred to as the “canonical” telematics system interfaces. These interfaces are consistent, regardless of the specific OEM that has been implemented. By keeping these interfaces consistent, the re-use of components is guaranteed, and OEM-specific development is isolated to particular areas of the system. Through these internal interfaces, the telematics system 210 is operable to integrate with any telematics device and mobile network operator (as illustrated at blocks 240, 242, 244, 246, 248, 250), which are highly variable and subject to change with each OEM or customer deployment.

In an exemplary embodiment, the telematics system 210 (through its platform of subsystems 212, 214, 216, 218, 220, 222, 224, 226, 228) provides over-the-air vehicle integration, PBX and telephony integration, content aggregation and integration, customer relationship management (CRM) and back office integration, IVR integration, call center integration, web portal integration, and smartphone integration.

The telematics services subsystem (TSS) 212 is the core telematics engine that acts on the telematics requests, manages service entitlement and device authentication, accesses data and routes to the appropriate individual and internal service components. The TSS 212 provides open interfaces to a number of service categories, e.g., safety and security, remote services, driver interactive vehicle applications (DIVA) services, diagnostics, navigation and infotainment.

The gateway services subsystem (GSS) 214 is responsible for network communication; telematics control unit (TCU) communication, protocol processing, encryption and transaction routing. The GSS 214 connects to any type of wireless or wired network and is built such that network transports and protocols are added as plug-ins to support future transports as well as telematics protocols. The GSS 214, based on business rules associated with transport, protocol and device type, routes both data and voice to the TSS 212. The GSS 214 also provides an open web services interface that translates protocol into an application level interface and vice versa. The GSS 214 routing rules, that control where a call type lands, are configured in a database and can be modified at anytime. Web interfaces update the routing rules.

The telematics system 210 provides over the air vehicle integration through a platform interface that simplifies integration with any telematics device through the management of all low-level processing while providing a high-level interface that allows developers to build simple protocol translator plug-ins 230 for various telematics devices, as will be described in further detail below. For example, the interface supports the following: device gateway for over the air communication of device protocol, call routing based on configurable parameters and a set of business rules, voice routing, wireless network management, and traffic monitoring.

Further, with respect to PBX and telephony integration, the telephony interface subsystem 224 has a built-in telephony engine that supports all major commercial computer telephony integration (CTI) systems. Additional plug-ins can be developed for additional PBX/CTI support.

Regarding CRM and back office integration, the data services subsystem 226 includes a data services engine that supports an open web services interface. This allows any third party developer to integrate their CRM solution into the connected vehicle platform. The connected vehicle platform does not depend on the availability of the CRM system for customer or vehicle data as the system automatically keeps a copy of the primary customer and vehicle data in its own database.

As for content aggregation and integration, the content services subsystem (CSS) 228 is a global platform designed to integrate various disparate sources of data and make them available to call centers and end users in vehicles or using mobile devices. Multiple inputs to the CSS 228 system, both stored locally and accessed through the internet, are used to provide maximum flexibility and richness of content. Data that is stored locally is taken from the original native format and converted into a structure that is compatible with the method in which it will be extracted and/or accessed. For example, the structures of POI, Traffic information, and other data sources are preserved and stored into a relational database where the content gateway then accesses the data and leverages the querying ability of the database. Data that is available from online sources can also be accessed through the same content gateway, thereby providing one interface through which the applications connect and allowing integration of new sources of data in a short amount of time.

More recently, OEMs have chosen to supplement operator-assisted services with Interactive Voice Response (IVR). The IVR subsystem or platform 216 provides an extensive voice and data interface that supports speech recognition technologies. The IVR subsystem 216 exposes all connected vehicle functions and services to the integrator and allows custom prompt to be built for specific brand and service types. IVR allows subscribers to interact with the IVR subsystem 216 on a self-service basis using the telephone as the communications channel. The IVR application performs the same functions as a human operator in a more cost effective and scalable way. The telematics system 210 treats both operators and IVR as delivery channels for the service. This model can be extended to include self-service applications accessed through the web services, provided by the consumer web interface 218, which allow the building of customer web portals or mobile applications that take advantage of self-service functions.

The call center interface 220 provides a comprehensive call center integration interface that allows a third party call center to integrate the platform of the telematics system 210 into the applications and tools used by the call center. The interfaces supplied provide access to telephony data, vehicle data, and customer data. The platform leverages the existing routing rules used by the third party call centers to route both voice and data to an available agent. A call center agent is able to receive a call (both voice and data). Further, the agent is able to pull customer and vehicle data from the connected CRM system as well as the available content sources. Finally, the agent is able invoke commands to send data to the vehicle.

The customer web interface (CWI) 218 of the telematics system platform allows third party developers to create web and Smartphone apps that access or control the vehicle. The CWI 218 supports authentication and authorization, which utilize enrollment information to allow access to the system functions and the vehicles services. The CWI 218 supports several categories of services and functionality including POI, geo-fence, DIVA, and remote access.

As will be discussed in further detail below, in order to service the telematics requests, the telematics system 210 does not need to know anything about how the service is being delivered, which makes it much easier to connect the telematics system 210 to new delivery channels like SMS-text and e-mail. In the same way that data coming into the telematics system 210 from the outside is separated from how it is used, data from the telematics system 210 can also be exposed to an end user in a number of different ways. Traditional telematics applications are operator-assisted. That is, a vehicle driver interacts with an operator at a call center and the operator interacts with the telematics system 210 through a call center application running on their computer and supported by the call center interface 220 and call center user interface 222

Considerable effort is required to connect telematics systems to specific sources of important data, such as customer information, vehicle information, and service-related information. Each OEM typically specifies where to get Point Of Interest (POI) or traffic data, for example. Each of these sources may format their data in a different way even though POIs are fundamentally the same. If the system were developed in a way that required each subsystem to know the details of every possible POI format, the code would quickly become cumbersome and difficult to maintain over time. To avoid such a situation, the telematics system 210 uses a technique called abstraction to separate the data from the details of where the data came from. Specifically, the telematics system 210 converts any data coming into the system from “outside” into a standardized or “canonical” form. All parts of the telematics system 210 understand this form, and are able to operate on the data regardless of where the data came from. This does not change the form of the data from the provider; it just has to pass through a piece of code that does nothing but convert data between the provider's format and the telematics system canonical format. This also means that if an OEM wants POIs from Bing™ Maps rather than Navteq™ for example, the only part of the telematics system 210 that has to be changed is the specialized piece of code, called an “adapter.”

As referenced above, the telematics system 210 is able to integrate any telematics device through the use of translators 230 that plug into the gateway services subsystem or platform 214. Translators 230 are specific to the protocol used to communicate with the TCU of a vehicle and they are responsible for converting messages from the vehicle into their canonical form so that the request can be interpreted and routed to the correct component for processing. Also referenced above, the telematics system 210 uses adapters 232 to convert external data formats into their canonical equivalent. As an example, adapters 232 plug into the content services subsystem or platform 228 to convert any source or type of content into its canonical form, which allows the CSS 228 to deliver the assorted content to telematics customers. Although FIG. 2 illustrates an adapter 232 plugged into the CSS 228, the telematics system 210 may include any number of adapters 232 plugged into any of the other subsystems 212, 214, 216, 218, 220, 222, 224, 226 for data conversion. Thus, the common code of the telematics system 210 is protected from the system interfaces by using small pieces of code, i.e., the translators 230 or adapters 232. This ensures that the subsystems 212, 214, 216, 218, 220, 222, 224, 226, 228 do not need to know where the data came from in order to be able to use the data. Accordingly, abstraction, i.e., separating how the data is acquired from how it is to be used, is a key principle in the exemplary telematics system 210.

The representation of data in canonical form also applies to the messages that are exchanged by the components of the telematics system 210 itself. Every part of the system 210 uses only the common form for all data. Crash data, remote service data, and diagnostic data always look the same inside of the telematics system 210, no matter what OEM or TCU model is being serviced. Knowledge of OEM-specific protocols, message formats and procedures is isolated to the periphery of the telematics system 210, allowing the system's core to remain unchanged.

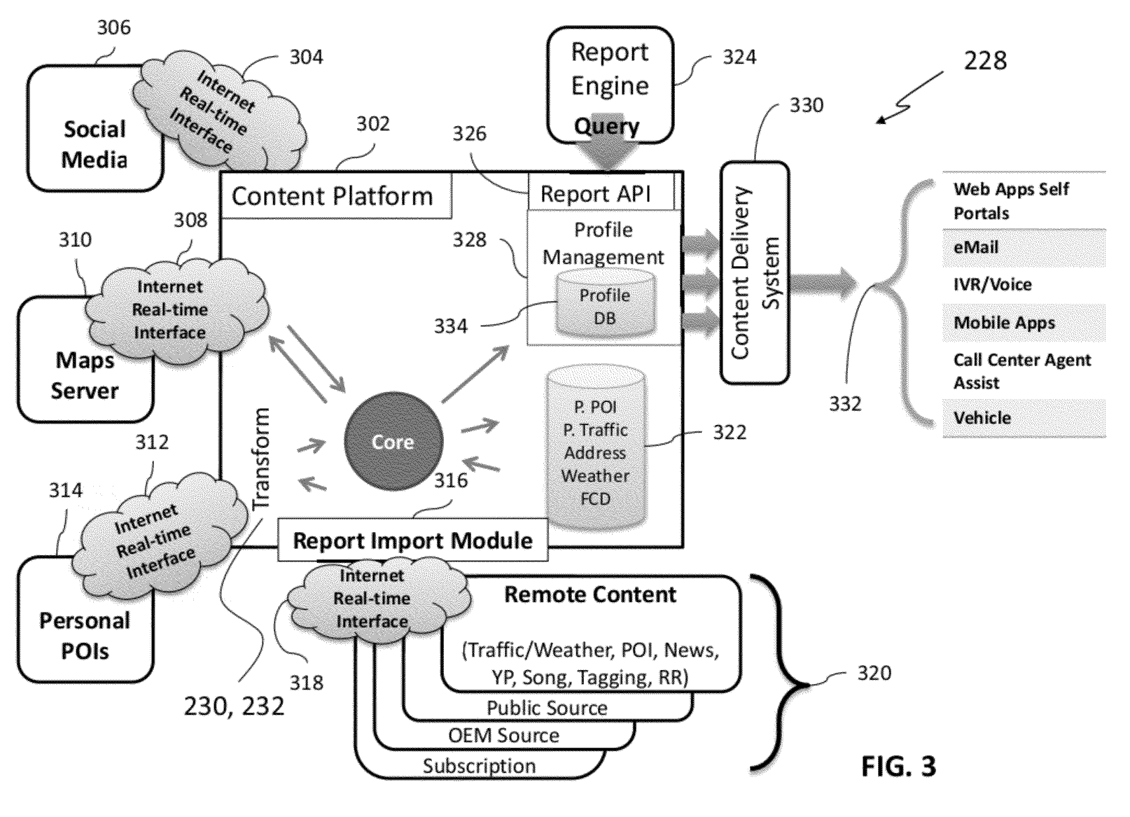

FIG. 3 is a diagrammatic illustration of a content services subsystem 228 in accordance with an exemplary embodiment. The CSS 228 provides a platform capable of real-time content integration from a variety of content sources, e.g., social networks, map servers, and various internet applications. Architecture 228 may be implemented in, for example, telematics system 210. Content platform 302 has a report application programming interface (API) module 326, a profile management module 328, a report import module 316, and a plurality of real-time interfaces 304, 308, 312, 318. Content platform 302 receives report queries from report engine 324 at report API 326. Content platform 302 connects to social media server 306, maps server 310, and personal POI server 314, via real-time interfaces 304, 308, and 312, respectively.

Remote import module 316 provides remote content 320 via real-time interface 318. Remote content may include, but is not limited to traffic, weather, POI, News, yellow pages, songs, tagging, and/or RR. The remote content may be from a public source, an OEM source, or provided by subscription.

Profile management module 328 is associated with profile database 334. In conjunction with database 322 and profile database 334, profile management module 328 can provide personalized POI and personalized traffic information. In addition, profile management module 328 can provide address, weather, and FCD information. Profile management module 328 provides content, information, reports, etc. via content delivery system 330 in response to requests initiated via a menu 332. Example categories that may be included in the menu 332 in order to initiate content delivery are web applications self portals, email, IVR/Voice, Mobile Applications, Call center agent assist, and vehicle. Content may be delivered, for example, to telematics system 210.

As shown, translators 230 and adapters 232 transform or convert the incoming data into its canonical equivalents so that the core of the CSS 228 remains unchanged Exemplary systems and processes for content delivery are described in co-pending U.S. Provisional Application Ser. No. 61/497,768, filed concurrently on Jun. 16, 2011, the contents of which has been incorporated.

A key feature of the telematics system 210 is the ability to minimize and isolate OEM-specific behavior. Keeping OEM details out of the core of the system 210 is, unfortunately, not entirely realistic. Beyond the mechanics of communicating with the vehicle and any potential sources of needed data, every service has specific logic associated with it. These are commonly referred to as “business rules” in the world of n-tier transaction processing. These business rules are a major component of the telematics system's core functionality. If all other OEM-specific code is at the periphery of the system 210, a question arises as to how the “minimize and isolate” philosophy is implemented at the core. The answer lies in inheritance. Inheritance is a programming construct that allows common functionality to be grouped together in what is called a “parent” or “base” class. If a programmer needs code that is very similar to the base, they can modify how that base works by deriving a new class from the parent. By making use of the parent's functionality, the developer does not need to write that code again. They need to focus solely on the ways in which the derived code differs from the parent. This kind of coding is at the core of implementing services to multiple OEMs from the same code base.

For example, consider a “geo-fence” service, which generates an alert to a subscriber informing them they are outside a virtual perimeter around a specific location. Suppose that OEM “A” wants the geo-fence to be defined by a geographic point combined with a radius, forming a circle around the point but OEM “B” prefers that the geo-fence is defined by four geographic points, forming a quadrilateral that serves as a perimeter. It is not very efficient to write code that assumes that the perimeter is a circle and then copy that code, substituting a quadrilateral for the circle. The telematics system 210 instead defines a geo-fence as the behavior required when an arbitrary perimeter is breached. This serves as the base for all geo-fence implementations. When work proceeds on OEM “A,” the developer simply derives a new class from the base, which implements a circular perimeter. All other functionality is provided by the base class. When work begins on OEM “B,” the developer derives a new class from the base, which implements the perimeter as a quadrilateral. The base class provides all other functionality. When new code inherits behavior from existing code, the potential of introducing errors is greatly reduced because the existing code is likely to have been tested in the context of other OEMs with major defects already found and corrected.

The platform of the telematics system 210 allows the implementation of a new OEM to be focused in specific areas, thus reducing the scope of effort required to bring an OEM to production. The functional areas that are typically affected by OEM-specific development and the types of changes required in each are detailed below.

Vehicle Communications and Protocols

In the absence of a widely adopted industry standard for communications between vehicles and telematics processing platforms, it is normal for an OEM to request specific features in its telematics solution. The exact combination of capabilities used by the vehicle is determined by the tradeoff between functionality and airtime charges. More sophisticated services generally require larger transfers of data, which, in turn, drive up communications costs and drive down the performance of the service.

The standards that do exist are not necessarily widely adopted and are routinely modified by the OEM to suit its own needs. This variability between OEMs generally requires development effort as a step in bringing the OEM to production. Advantageously, the telematics system 210 in accordance with exemplary embodiments treats communications with the vehicle separately from the implementation of the telematics services. This allows the communications components to change without necessarily affecting the behavior of the service.

Communications with the vehicle are accomplished in three steps: the network connection; the transport wrapper, and the telematics protocol. The network connection acts a pipe through which the telematics data flows. These pipes are provided by the wireless network and terminate inside the network provider's network. Next, the transport wrapper helps to regulate the amount of data that arrives at any one time. Here, the OEM generally chooses between short messages (SMS for GSM and CDMA carriers) or packet data (GPRS for GSM carriers, or 1xRTT for CDMA carriers). Short messages are generally chosen for services that require little data, while packet data is generally chosen for services that produce large amounts of data. Finally, the protocol establishes the rules that the telematics system 210 and the vehicle follow when communicating with each other. While these components are generally very closely related, they are distinct elements within the telematics system 210. This means that there is less effort necessary to change transport wrappers, for example, and that the code that implements that wrapper can be re-used even when the network and protocol are different.

Service Implementation

When customers think of a service, they are generally envisioning having their doors unlocked or hearing an operator speak to them after an airbag deployment. From a telematics system perspective, a service is simply a set of actions and the rules that determine what happens after the action is carried out. This is sometimes referred to as “business logic,” or “business rules.” These form the essence of what are consider to be services as defined herein. For the most part, implementation of the business logic for a service, such as Remote Door Unlock (RDU), is the same for every OEM. However, the capabilities of the TCU in the vehicle may allow an unlock delay. Rather than replacing the business logic for an OEM to allow for a minor variance in the service, the telematics system 210 is implemented in a way that the “base” implementation of RDU assumes that the unlock delay is zero, thus implementing the delay for a specific OEM becomes an exercise in configuring the delay correctly.

Data Sources

One of the widely varying aspects of different OEM programs is the choice of data providers for content and vehicle information. Traditionally, this has been an area where considerable effort is required to understand the format of the data, the mechanics behind accessing the data, and how to present the data back to the system so that it can be operated upon or delivered as part of the service.

As provided in more detail above, the telematics system 210 is configured under the premise that all data of a specific type should look the same, regardless of the source. This means that POIs, contacts, vehicle data and other data that is stored outside of the telematics system 210 should be made to look uniform before the telematics system 210 is able to process it. By making this a valid assumption for all components within the telematics system 210, knowledge of the data has been disconnected from the business logic. This does not remove the need to be able to connect to external sources of data; it just isolates it into a specific part of the code. The code, i.e., content or data adapters 232, know the specifics of how POIs (for example) are stored and retrieved. Once adapters 232 have been developed for a common source, e.g., Bing™ maps, they can be re-used for any OEM.

Accordingly, the telematics platform of the inventive telematics system 210 accelerates the implementation of OEM programs and improves the overall reliability of the system 210 through code re-use, isolation of OEM-specific code, the use of modern object-oriented coding techniques, and modular architecture.

The telematics system 210 is modular, in that each functional part of the system 210 must be in order to fit tightly with the rest of the system 210. By breaking functionality out into discrete components, it is possible to replace individual elements as needed. This may be due to specific OEM requirements or due to improvements in the implementation of a specific function. A key element of modularity in the telematics system 210 is that details which are OEM-specific are not propagated into core code. This helps to keep most code re-usable by multiple OEMs and allows leveraging of that code repeatedly once it has been written.

Because the telematics system 210 needs to be able to serve both large and small OEM programs, it is important that the functional components of the system do not make assumptions about the physical deployment of the system 210. Adhering to this rule ensures maximum flexibility in deploying the system 210. Design of the telematics system 210 is performed to make possible running of the entire system 210 on a single server, although to do so would be impractical for an actual OEM. The specific benefit of this is that, as subscriber and call volumes increase, additional instances of the system components can be added to increase capacity. Adding a component this way is independent of the number and location of the other components that make up the system 210.

The telematics system 210 has the unusual ability to be deployed either as a stand-alone system or as an integrated platform operable to service many customers. A single telematics system is capable of executing services for customers of different OEMs at the same time, even if those services behave differently. The challenge in achieving this capability is not necessarily in having the system to perform multiple functions at the same time. The challenge is doing that while minimizing the duplicate functionality within the system. The telematics system 210 manages multiple implementations of services efficiently and reduces the effort and time-to-market involved with launching subsequent OEM programs.

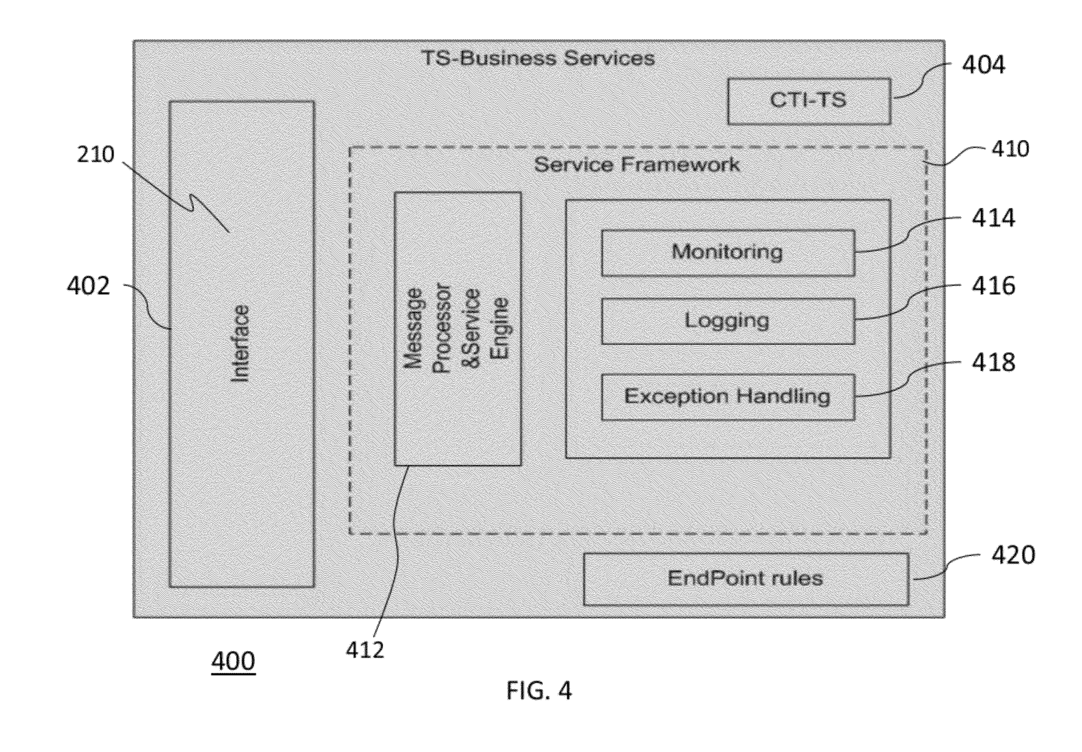

The telematics system 210 makes extensive use of code frameworks to standardize the behavior of common parts of the system 210. Moving data, for example, is something that every part of the system 210 has to do in a consistent, predictable way. If each component of the system 210 implemented this fundamental task differently, it is unlikely that the system 210 would be reliable or consistent. Frameworks make up the “bones” of the system 210 like the framing of a house. Examples of where the telematics system 210 uses frameworks are: sending and receiving data; auditing operations; reading and writing configuration data; handling error conditions; and service request routing. FIG. 4 shows a pictorial representation e.g., a diagram 400, of how frameworks relate to the functional components within the telematics system 210. Diagram 400 includes a service framework 410, a computer-telephony integration (CTI) unit 404, and endpoint rules 420. Diagram 400 also includes an interface 402 to telematics system 210. Service framework 410 includes message processor and service engine 412, monitoring unit 414, logging unit 416, and exception handling unit 418. In this example, the service framework 410 is responsible for loading the correct message processor and service engine code, depending on what kind of service request is received. An advantage of the framework 410 is that, even in circumstances where the service engine 412 must be replaced for a specific OEM, the coding effort is limited to the engine itself, and none of the surrounding code is affected.

Two key elements of providing customized services within a standardized framework are the ability to apply user preferences and OEM-specific routing rules for services. Since different OEMs may prefer that information-type calls be handled by IVR, and safety calls be handled by human operators, the telematics platform 210 provides a set of routing rules that are consulted for each service request. The routing rules allow each OEM to decide how calls are handled based on OEM, service requested, country of residence, language, and other factors. Making this capability a basic function of the telematics system 210 means that OEMs are not forced into a particular service model. An OEM may also decide to segment their services in order to better support their brand strategy. In a similar way, the telematics system 210 allows customers to establish preferences for certain types of data that they can receive. This allows them to override some of the OEM defaults with data using the customer's personal account. News, weather, and traffic feeds are prime candidates, but any Web-accessible information source could be a data source.

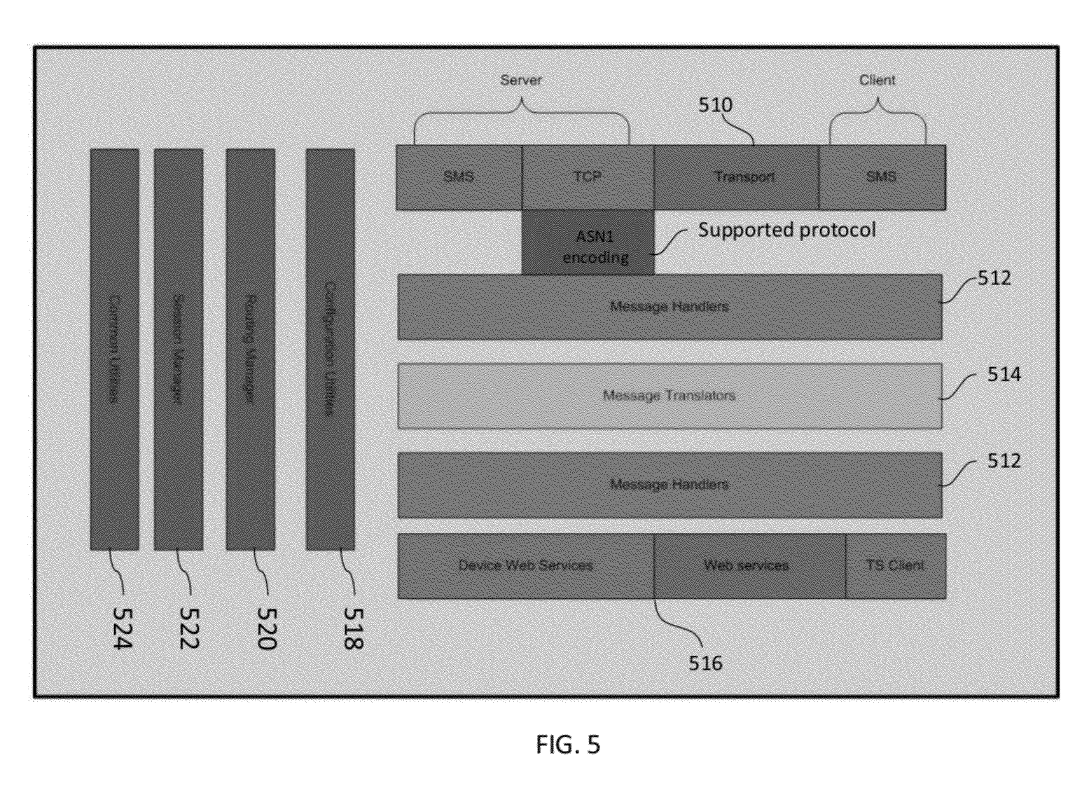

The architectural consistency or flexibility of the telematics system 210 can potentially introduce incompatibilities between individual components. To avoid this situation, every functional area is developed according to the same set of rules. Referring to FIG. 5, the layered architecture of the telematics system comprises four major modules: data transport 510, message handlers 512, translators 514, and web services 516. Data transport module 510 can support SMS transport protocol for communication via a client. Data transport module 510 can also support SMS and TCP transport protocols for communication via a server. Abstract Syntax Notation One (ASN1) encoding may be used in conjunction with the supported communication protocols. Web service 516 may include device web services and telematics system client webs services. Other modules may include configuration utilities module 518, routing manager module 520, session manager module 522, and common utilities module 524.

FIG. 5 depicts an exemplary interface between the telematics system 210 and CTI/PBX systems, in which web services are exposed as end-points. The server side application is agnostic to vendor changes and provides easy scalability to new locations.

Telematics Platform for the Mass Market

The flexibility in deploying the telematics system 210 also pays dividends when considering new markets. Because of the clear distinction between external and internal data, the telematics system 210 can be deployed in a third-party environment with a nominal amount of incremental effort. Consider the following scenario: a large OEM, which already receives telematics services from the telematics system 210 in North America, wants to receive the same services in a foreign country, which imposes significant tariffs on the importation of data processing equipment and requires foreign businesses to partner with a local company instead of opening a local subsidiary. To deploy a full telematics system 210, the owner or operator of the telematics system 210 would have to provide servers for the core telematics system 210, desktops for the call center, localization of all user interfaces, a database server and DBMS software, content licenses for locally sourced data, etc.

Building out a full implementation of the telematics system 210 for the local market would require significant capital investment even if it could be assumed that the local market would use the same protocols as in the North American market. The telematics system 210 is configured so that the platform can be deployed as a mass-market system 210. That is, the platform can be licensed as a software-only component to a foreign entity that would be responsible for all other aspects of the business. This is possible due to the separation of the telematics function of the telematics system 210 from the external supporting components.

To satisfy the scenario above, the local partner would need to provide: all hardware for the runtime, call center, communications and telephony; a computer telephony integration solution with workforce automation capabilities, or software PBX; a call center user interface developed to work with the application programming interface (API); an industry-standard relational database management system (RDBMS) with SQL support; and APIs for all content providers. The owner of the telematics platform 210 would provide: the telematics platform software with OEM specific functionality; software adapters for communications, computer-telephony integration (CTI), RDBMS, and content. This scenario assumes that the services are essentially the same in North America and the local market, but it should be clear that the barriers to entry are significantly reduced.

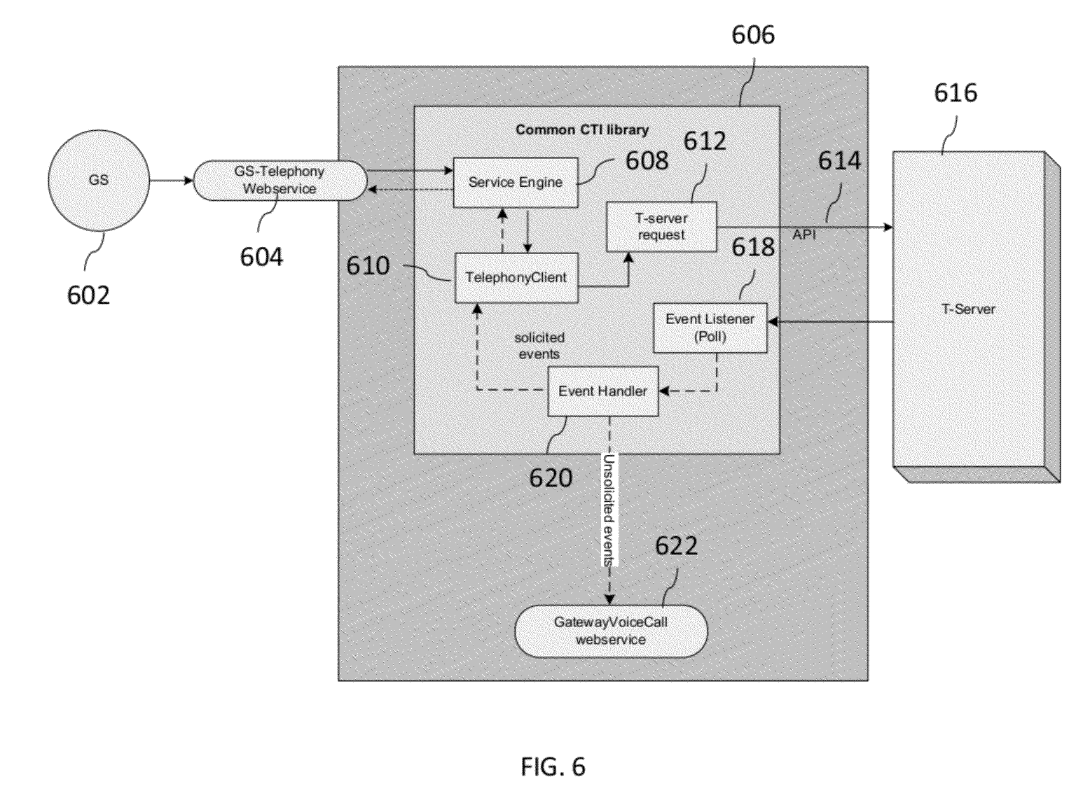

FIG. 6 is a block diagram 600 depicting a telematics system interface in accordance with an exemplary embodiment. Diagram 600 illustrates an example implementation of a gateway services (GS) subsystem 602, e.g., GS 214, interfacing with a telephony server 616 using a common CTI library function 606. GS 602 sends a request to initiate a telephony webservice using GS-Telephony webservice 604. GS-Telephony web service 604 forwards the request to service engine 608 of a common CTI library 606. Service engine 610 forwards the request to a telephony client 610. A telephony server request 612 is communicated to a telephony server 616 using an API 614. An event listener 618 polls messages from the telephony server 616 for events related to the request. Event handler 620 sends solicited events to the telephony client 610, which, in turn, forwards the solicited events to the GS-Telephony web service 604 via the service engine 608. An event handler 620 forwards unsolicited events to a Gateway Voice Call webservice 622.

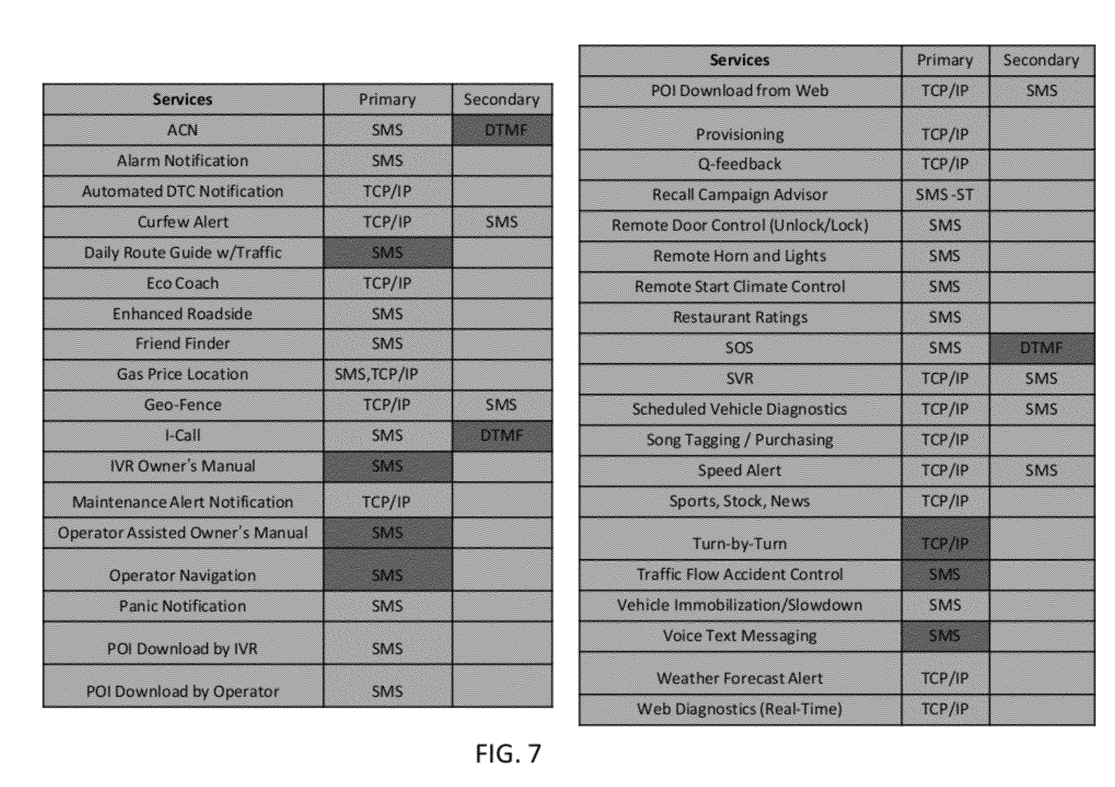

The telematics system 210 of the present invention can be used for implementing any of the exemplary services listed in FIG. 7, in addition to any other services disclosed in U.S. Provisional Application Ser. Nos. 61/497,699, 61/497,705, 61/497,715, 61/497,768, and 61/497,849 (all of which have been incorporated by reference herein). Example services shown in FIG. 7 are: ACN, automatic alarm notification, automated Diagnostic Trouble Codes (DTC) notification, curfew alert, daily route guide with traffic, eco coach, enhanced roadside, friend finder, gas price location, geo-fence, Information call (I-Call), Interactive Voice Recognition (IVR) owner's manual maintenance alert notification, operator assisted owner's manual, operator navigation, panic notification, POI download by IVR, POI download by operator, POI download from Web, provisioning, Q-feedback, recall campaign advisor, remote door control (unlock/lock), remote horn and lights, remote start climate control, restaurant ratings, SOS, Stolen Vehicle Recovery (SVR), scheduled vehicle diagnostics, song tagging/purchasing, speed alert, sports/stock/news, turn-by-turn, traffic flow accident control, vehicle immobilization/slowdown, voice text messaging, weather forecast alert, and Web diagnostics (real-time). The example services may be provided in accordance with primary and secondary communication protocols. Example primary communication protocols include SMS, TCP/IP, and SMS-ST. Example secondary communication protocols include DTMF and SMS.

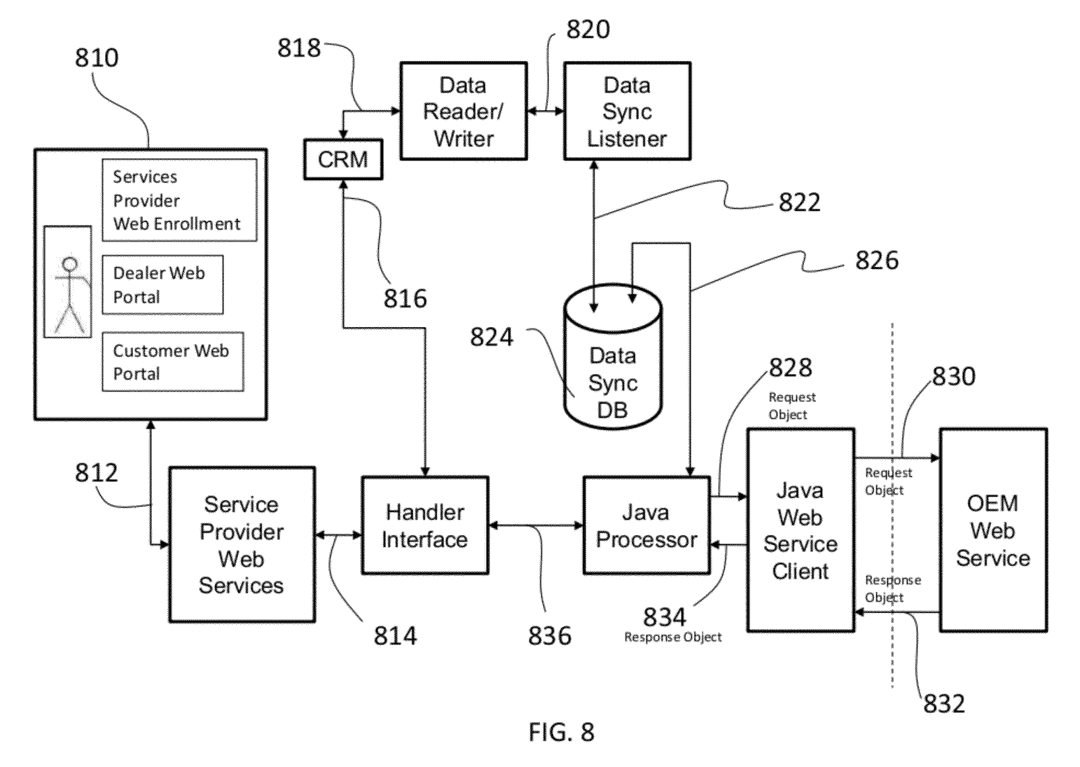

FIG. 8 illustrates an exemplary process through which CRM or subscription data (e.g., subscription information for a primary subscriber, additional subscribers, or product bundles) is exposed to third parties, e.g., an OEM. As an example, during an “enrollment” event, where a customer wishes to enroll in a new service, information, such as account information and all contacts, products, and start and end dates, is synced with the OEM web service. As illustrated in the example of FIG. 8, the customer enrolls in a new service (block 810), either through the telematics services provider's web enrollment, through a dealer's web portal, or a customer web portal. In an exemplary embodiment, the customer enrolls through the dealer's web portal, i.e., the sales person at the dealership enters the customer's subscription data at the dealer's web portal. Customer preferences can be set at this stage. The data is sent to the web server of the telematics service provider (arrow 812) and through the handler interface (arrow 814) to the CRM (arrow 816), which has all of the profile data of the customer or primary subscriber. The CRM then generates and sends an XML message (arrow 818) to a data reader/writer, e.g., MQSERIES®, which sends the data to a data sync database 824 through the data sync listener (arrows 820 and 822). The JAVA® processor and web service client delivers the data from the data sync database 824 to the OEM server (arrows 826, 828, 830). Typically, the telematics service provider receives an acknowledgement, e.g., a customer ID, that the data sync for the “enrollment” event was successful (indicated by the “response object” arrows 832 and 834 and the arrow 836 back to the handler interface). The customer ID can then be used for subsequent data sync transactions on an account.

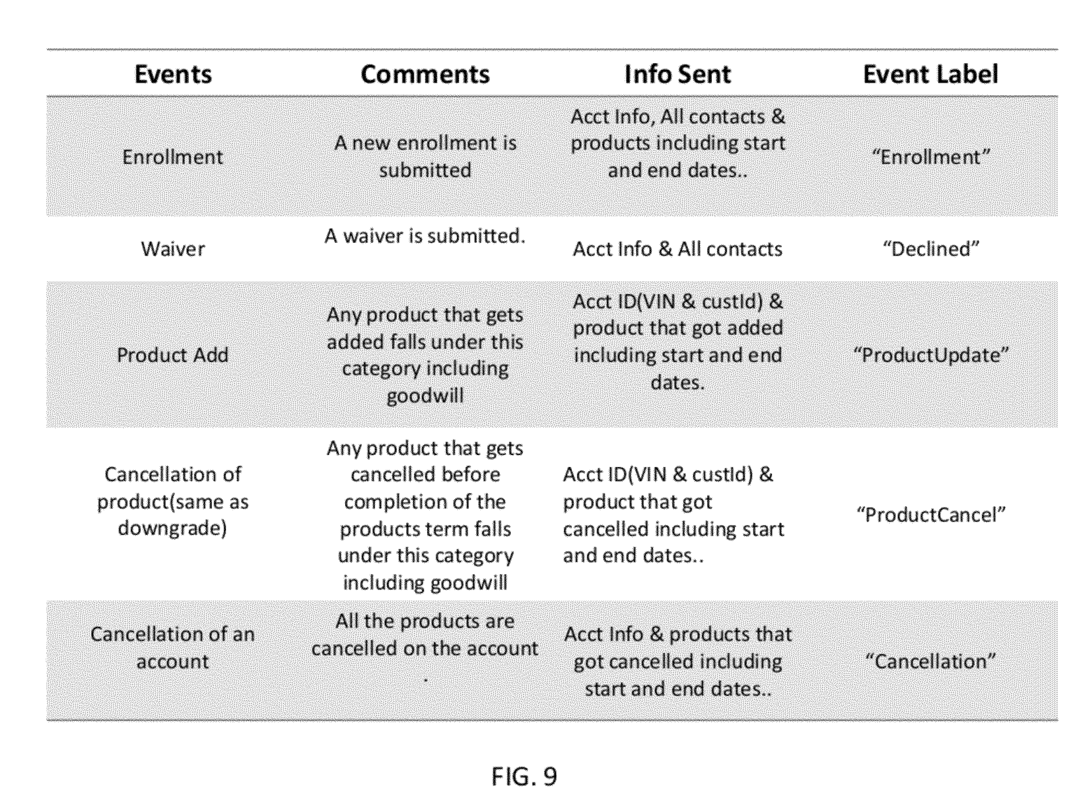

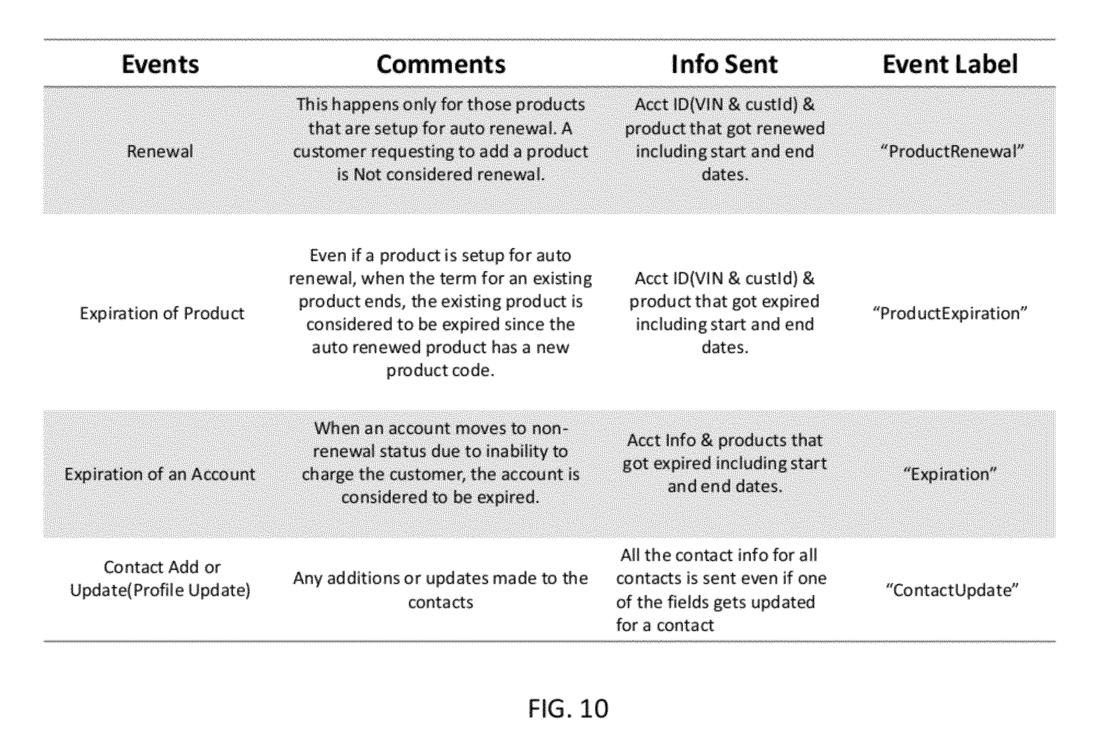

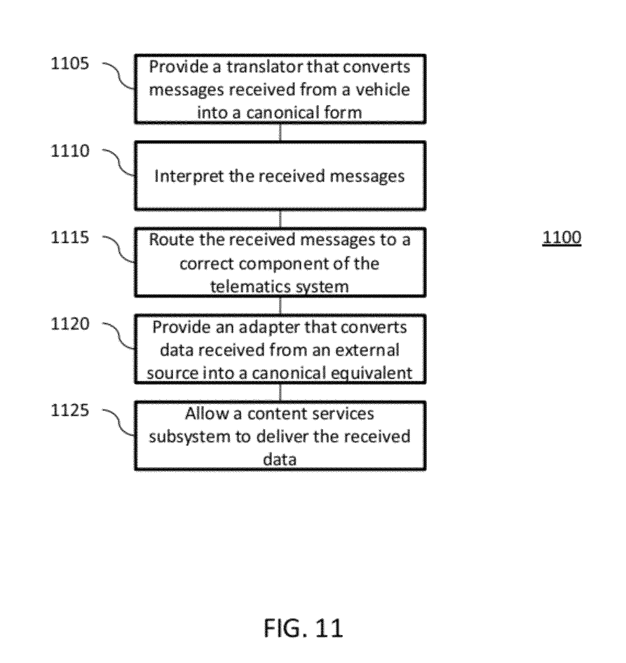

Examples of events in which the data sync process can be used to synchronize additional subscription information are shown in FIGS. 9 and 10. As shown in FIG. 9, an enrollment event has an event label of “Enrollment” and information that is sent can include account information, all contacts, all products, and start and end dates.

A waiver event has an event label of “Declined” and information that is sent can include account information and all contacts.

A product addition event has an event label of “ProductUpdate” and the information that is sent includes account identification, e.g. vehicle identification number (VIN) and customer identifier, product that was added, and start and end dates. Any product that gets added falls under this category including goodwill.

A product cancellation event is processed the same as a downgrade event and has an event label of “ProductCancel”. Information that is sent for a product cancellation event can include account identification (VIN and customer ID), the product that was canceled, and start and end dates. Any product that is canceled before completion of the product's term falls under this category, including goodwill.

An account cancellation event has an event label of “Cancellation”. In this event, all of the products on the account are canceled. Information that is sent can include account information, products that were canceled, and start and end dates.

As shown in FIG. 10, a renewal event has an event label of “ProductRenewal”. This event happens only for those products that are set up for automatic renewal. A customer requesting to add a product is not considered an auto renewal event. Information that is sent can include account identification (VIN and customer ID), the product that was renewed, and start and end dates.

An expiration of product event has an event label of “ProductExpiration”. Even when a product is set up for auto renewal, when the term for an existing product ends, the existing product is considered to be expired because the automatically renewed product has a new product code. Information that is sent can include account identification (VIN and customer ID), the product that expired, and start and end dates.

An expiration of a product event has an event label of “Expiration”. When an account moves to non-renewal status due to an inability to charge the customer, the account is considered to be expired. Information that is sent can include account information, the products that expired, and start and end dates.

A contact add or update event, e.g., profile update, has an event label of “ContactUpdate”. A profile update is any additions or updates made to the contacts. All of the contact information for all contacts is sent even if only one of the fields gets updated for a contact.

FIG. 11 illustrates a method 1100 for providing abstraction in a telematics system, according to one exemplary embodiment. A translator that converts messages received from a vehicle into a canonical form is provided at step 1105. At step 1110, the translator interprets the received messages and routes the received messages to a correct component of the telematics system at step 1115. An adapter that converts data received from an external source into a canonical equivalent is provided at step 1120. The adapter allows a content services subsystem to deliver the received data at step 1125.

In one exemplary embodiment, determining an origin of the messages or data is unnecessary in order to use the messages or data. The common code of the telematics system 210 is protected from the system interfaces by using small pieces of code, i.e., the translators 230 or adapters 232. This ensures that the subsystems 212, 214, 216, 218, 220, 222, 224, 226, 228 do not need to know from where the data came in order to be able to use the data. Accordingly, abstraction, i.e., separating how the data is acquired from how it is to be used, is a key principle in the exemplary telematics system 210.

In one exemplary embodiment, messages exchanged by components of the telematics system are represented in canonical form. The representation of data in canonical form also applies to the messages that are exchanged by the components of the telematics system 210 itself. Every part of the system 210 uses only the common form for all data. Crash data, remote service data, and diagnostic data always look the same inside of the telematics system 210, no matter what OEM or TCU model is being serviced. Knowledge of OEM-specific protocols, message formats and procedures is isolated to the periphery of the telematics system 210, allowing the system's core to remain unchanged.

In one exemplary embodiment, the received data comprises at least one of points of interest, contacts, vehicle data, and other data stored outside of the telematics system. The telematics system 210 is configured under the premise that all data of a specific type should look the same, regardless of the source. This means that POIs, contacts, vehicle data, and other data that is stored outside of the telematics system 210 should be made to look uniform before the telematics system 210 is able to process it. By making this a valid assumption for all components within the telematics system 210, knowledge of the data has been disconnected from the business logic. This does not remove the need to be able to connect to external sources of data; it just isolates it into a specific part of the code. The code, i.e., content or data adapters 232, know the specifics of how POIs (for example) are stored and retrieved. Once adapters 232 have been developed for a common source, e.g., Bing™ maps, they can be re-used for any OEM.

In one exemplary embodiment, the telematics system is modular and comprises discrete components. The telematics system 210 is modular in that each functional part of the system 210 must be in order to fit tightly with the rest of the system 210. By breaking functionality out into discrete components, it is possible to replace individual elements as needed. This may be due to specific OEM requirements or due to improvements in the implementation of a specific function. A key element of modularity in the telematics system 210 is that details which are OEM-specific are not propagated into core code, i.e., free of OEM-specific details. This helps to keep most code re-usable by multiple OEMs and allows leveraging of that code repeatedly once it has been written.

Because the telematics system 210 needs to be able to serve both large and small OEM programs, it is important that the functional components of the system do not make assumptions about the physical deployment of the system 210. Adhering to this rule ensures maximum flexibility in deploying the system 210. The design of the telematics system 210 is such that it would be possible to run the entire system 210 on a single server, although to do so would be impractical for an actual OEM. The specific benefit of this is that, as subscriber and call volumes increase, additional instances of the system components can be added to increase capacity. Adding a component this way is independent of the number and location of the other components that make up the system 210.

In one exemplary embodiment, additional instances of at least one of the discrete components are added to increase capacity. The design of the telematics system 210 is such that it would be possible to run the entire system 210 on a single server, although to do so would be impractical for an actual OEM. The specific benefit of this is that, as subscriber and call volumes increase, additional instances of the system components can be added to increase capacity. Adding a component this way is independent of the number and location of the other components that make up the system 210.

In one exemplary embodiment, the telematics system is implemented as a stand-alone system. In another exemplary embodiment, the telematics system is implemented as an integrated platform operable to service many customers.

In one exemplary embodiment, the telematics system uses code frameworks to standardize a behavior of common parts of the telematics system. Frameworks make up the “bones” of the system 210 like the framing of a house. Examples of where the telematics system 210 uses frameworks are: sending and receiving data; auditing operations; reading and writing configuration data; handling error conditions; and service request routing.

In one exemplary embodiment, the telematics platform provides a set of routing rules that are consulted for each instance of a service request. The routing rules allow each OEM to decide how calls are handled based on OEM, service requested, country of residence, language, and other factors.

Although the foregoing specific details describe a preferred embodiment of this invention, persons reasonably skilled in the art of twill recognize that various changes may be made in the details of the method and apparatus of this invention without departing from the spirit and scope of the invention as defined in the appended claims. Therefore, it should be understood that this invention is not to be limited to the specific details shown and described herein. The above-described embodiments should be regarded as illustrative rather than restrictive. Accordingly, it should be appreciated that variations to those embodiments can be made by those skilled in the art without departing from the scope of the invention as defined by the following claims.

1. A method for providing abstraction in a telematics system, comprising:
providing a telematics system with components, the components including:
a translator that converts messages received from a vehicle into a canonical form, the translator:
interpreting the received messages; and
routing the received messages to a correct component of the telematics system; and
an adapter that converts data received from an external source into a canonical equivalent, the adapter being operable to allow a content services subsystem to deliver the received data.

2. The method of claim 1, wherein determining an origin of the messages or the data is unnecessary in order for at least one of the translator and the adapter to use the messages or the data.

3. The method of claim 1, which further comprises exchanging messages by the components represented in canonical form.

4. The method of claim 1, wherein the received data comprises at least one of points of interest, contacts, vehicle data, and other data stored outside of the telematics system.

5. The method of claim 1, wherein the components of the telematics system are modular and discrete.

6. The method of claim 5, wherein code for the components of the telematics system is free of original equipment manufacturer (OEM) specific details.

7. The method of claim 5, which further comprises:
providing the components as discrete components; and
adding additional instances of at least one of the discrete components to increase capacity.

8. The method of claim 1, which further comprises implementing the telematics system as a stand-alone system.

9. The method of claim 1, which further comprises implementing the telematics system as an integrated platform operable to service many customers.

10. The method of claim 1, which further comprises having the telematics system use code frameworks to standardize a behavior of common parts of the telematics system.

11. The method of claim 10, wherein the code frameworks are operable to send and receive the data.

12. The method of claim 10, wherein the code frameworks are operable to audit operations.

13. The method of claim 10, wherein the code frameworks are operable to read and write configuration data.

14. The method of claim 10, wherein the code frameworks are operable to handle error conditions.

15. The method of claim 10, wherein the code frameworks are operable to route service requests.

16. The method of claim 1, which further comprises providing the telematics system with a set of routing rules that are consulted for each instance of a service request.

17. A telematics system, comprising:
components including:
a translator operable to convert messages received from a vehicle into a canonical form, to interpret the received messages, and to route the received messages to a correct one of the components; and
an adapter operable to convert data received from an external source into a canonical equivalent and to permit delivery the received data by a content services subsystem.

18. The method of claim 1, wherein:
the telematics system is modular; and
the components are discrete components.

19. The method of claim 1, wherein the components are implemented as a stand-alone telematics system.

20. The method of claim 1, wherein the components are implemented as an integrated telematics platform operable to service many customers.
